(19) United States
(12) Patent Application Publication
(10) Pub. No.: US 2026/0056929 A1
(43) Pub. Date: Feb. 26, 2026

(54) DATA STRUCTURE WITH COLD DATA SELF EVICTION OF AND MULTIPLE RETENTION POLICIES

(71) Applicant: Ariel SHTUL, Jerusalem (IL)

(72) Inventor: Ariel SHTUL, Jerusalem (IL)

(21) Appl. No.: 19/308,240

(22) Filed: Aug. 24, 2025

Related U.S. Application Data
(60) Provisional application No. 63/686,760, filed on Aug. 24, 2024.
(60) Provisional application No. 63/730,979, filed on Dec. 12, 2024.

(51) Int. Cl. G06F 16/22

(52) U.S. Cl. CPC G06F 16/2255; G06F 16/2272; G06F 16/2282

(57) ABSTRACT

A hot table is a data structure designed to manage hot data while efficiently discarding cold data. The base layer of it are hash tables with predetermined and preallocated number of buckets and slots, unlike tables based on linked lists. A hot table has complexity of O(1) for SET/GET/DEL commands and no overhead by harnessing the kicking mechanism to discard cold data, acting as a garbage collector. The metadata kept with the key allows for complex eviction policies such as LRU and LFU. Hot tables impose minimal performance and memory overhead which makes them suitable for deployment in both hardware and software development environments.

### RELATED APPLICATION(S)

This application claims the benefit of priority under 35 USC § 119(e) of U.S. Provisional Patent Applications Nos. 63/730,979 filed on Dec. 12, 2024 and 63/686,760 filed on Aug. 24, 2024. The contents of the above applications are all incorporated by reference as if fully set forth herein in their entirety.

### FIELD AND BACKGROUND OF THE INVENTION

The present invention, optionally, relates to computer science and, more particularly, but not exclusively, to data structure design.

Data structures form the foundation of numerous computational processes relying on memory capacity and CPU time to perform operations such as setting, retrieving, and deleting data stored in memory. Common examples of data structures include arrays, linked lists, tries, heaps, and hash tables. Each of these structures has its own advantages and disadvantages, but they all share one characteristic: they retain data until it is explicitly deleted. Deletion can be handled lazily through checking data for expiration upon access, or actively through mechanisms like garbage collection. However, garbage collection incurs substantial performance and memory overhead, and setting expiration often requires additional commands. A circular buffer can be used as a simple Least Recent Used (LRU) data structure, but lookups in an LRU have O(n) complexity. Alternatively, a combination of a hash table with a linked list can be used, but it suffers from a high memory footprint and CPU usage.

In today's fast-paced environment, many applications encounter scenarios where data quickly becomes irrelevant and needs to be discarded to free up memory for new, more relevant data. This creates a demand for data structures that can maintain a constant size, rather than expand with the size of the data they store.

Hash tables are widely used for storing large volumes of data, primarily due to their O(1) complexity for SET, GET, and DELETE operations. Their challenge is a low utilization of memory when the number of pieces of data equal to the initial size. As a workaround, a hash table can be overloaded with data, e.g., by storing more data than its initial capacity, improving memory utilization at the cost of slowing down all operations. This slowdown is caused by an increased number of memory jumps to a next linked list node and a high likelihood of page faults, making hash tables impractical for certain applications.

A useful data structure that attempts to remedy this deficiency is the Cuckoo table, which was first introduced in 2001 and has since been implemented in multiple important systems, including the Linux kernel. Cuckoo tables offer better memory utilization than traditional hash tables, with GET and DELETE operations requiring checks at no more than two memory addresses per operation. A Cuckoo table consists of a single hash table with two hash functions or two hash tables, each containing an array of buckets, with each bucket holding one or more slots for data storage. Some implementations of the Cuckoo table use one hash table associated with two different hash functions instead of two hash tables. This approach has limitations in comparison to having two separate tables. During any operation, data is hashed twice, and the resulting hash values are used as addresses for the respective buckets. For GET and DELETE operations, all slots at the specified buckets are checked for the presence of the data. During an insert operation, if all slots in buckets at both addresses are occupied, one of the existing pieces of data is evicted from a slot to make room for the new data being inserted. This process is often referred to as “kicking”. The evicted data is then rehashed for the other hash table and the process continues until an empty slot is found or the table is deemed full upon a preconfigured number of evictions, requiring resizing and rehashing.

### SUMMARY OF THE INVENTION

Optionally, hot tables comprise one or more hash tables with designated buckets, slots and an indexer storing the capacity of the hot table and the current maximum index value.

As used herein, the term “total capacity” means the theoretical upper limit of elements that may be stored in a configured hot table, computed as the product of the number of hash tables in the hot table, the number of buckets per hash table, and the number of slots per bucket.

As used herein, the term “capacity” means a configured capacity designated for hot elements which is generally lower than total capacity of a hot table, with the excess capacity serving to optimize insert operation performance. If an index stored in a slot is less than the least valid index, computed as the maximum index minus the capacity, the data in the slot is considered cold and may be overwritten by an insert operation or removed by a read operation performing lazy garbage collection.

According to an aspect of some embodiments of the present invention there is provided a system comprising a storage comprising one or more hash tables, each associated with one or more hash functions and comprising a plurality of buckets, each bucket comprising one or more slots, each slot comprising an integer index, a key and a value, a maximum index and a capacity value, one or more processors configured to perform the following in each of a plurality of iterations performed for insertion of a new key associated with a new value: apply a first hash function associated with a first hash table to the new key to compute a hash value, responsive to existence of a first slot in a bucket associated with an address derived from the hash value, the first slot associated with an invalid integer index, place the new key and the new value in the first slot, otherwise kick a key and a value comprising a second slot in the bucket to a third slot, and responsive to the first slot comprising a prior key and a prior value, remove the prior key and the prior value and release their resources.

Optionally, moving a key and a value comprises applying one of a second hash function associated with a second hash table or a third hash function associated with the first hash table to the key to compute a second hash value, responsive to a slot in a bucket associated with an address derived from the second hash value and an invalid integer index comprising a prior key and a prior value, moving the prior key and the prior value to a third slot, and responsive to a predetermined event, associating the one or more hash tables with new hash functions and rehashing the one or more hash tables.

Optionally, the one or more processors are further configured to perform the following: allocate an additional empty hash table or destroy an existing empty hash table.

Optionally, the system further comprises a programmatic interface enabling external manipulation of the maximum index, and wherein responsive to a predetermined event the system allocates an additional empty hash table.

Optionally, the system further comprises a sorter associative array and a comparison function, wherein a slot further comprises at least one of a score, a counter or a fingerprint.

Optionally, the one or more processors are further configured to perform the following: apply a respective hash function associated with a hash table to a key to compute a hash value, perform at least one of determine a second score value as a first score value plus a slot score associated with the hash value or determine a second score value as the first score value,
replace the slot score associated with the hash value with the second score value, apply the comparison function to the second score value and a threshold value of the sorter associative array, and responsive to the comparison function returning true, replace a respective key value in the sorter associative array with the second score value, apply the comparison function to the second score value and a score of each key in the sorter associative array, and responsive to the comparison function applied to a score of a key in the sorter associative array returning false, prune the key from the sorter associative array.

Optionally the one or more processors are further configured to perform the following: apply a respective hash function associated with a hash table to compute a hash value of a key, increment a count of a slot in a bucket associated with an address derived from the hash value, apply the comparison function to the count of the slot and a threshold value of the sorter associative array, and responsive to the comparison function returning true, replace a respective key value in the sorter associative array with the count of the slot, apply the comparison function to the count of the slot and a count of each key in the sorter associative array, and responsive to the comparison function applied to a count of a slot in the sorter associative array returning false, prune the key from the sorter associative array.

Optionally, the comparison function further comprises a comparison of a predetermined threshold length and the sorter associative array size.

Optionally, the comparison function further comprises a comparison of a predetermined minimum significant score value and the second score value.

Optionally, the comparison function further comprises a comparison of a predetermined minimum significant count value and the count of the slot.

Optionally, the system further comprises a second system and a non-transitory computer readable medium storing executable instructions that, when executed by a processor, cause the system to perform the following: responsive to a timer event, create a copy of the sorter associative array of the system, and insert the copy of the sorter associative array into the second system.

Optionally, a slot further comprises a Boolean field indicating its protection from eviction.

Optionally, a bucket further comprises a plurality of candidate fingerprints, and the one or more processors are further configured to perform for insertion of a new key associated with a new value: perform one or more condition checks, the condition checks comprising determining presence of at least one of an empty slot or a cold slots in the bucket associated with the address derived from the hash value and determining presence of the hash value in the plurality of candidate hash values, and responsive to determining that none of the conditions checks is satisfied, abort performing insertion of the new key associated with the new value.

According to an aspect of some embodiments of the present invention there is provided a processor-implemented method for data insertion, comprising: applying a first hash function associated with a first hash table to the new key to compute a hash value, responsive to existence of a first slot in a bucket associated with an address derived from the hash value, the first slot associated with an invalid integer index, placing the new key and the new value in the first slot, otherwise kicking a key and a value comprising a second slot in the bucket to a third slot, and responsive to the first slot comprising a prior key and a prior value, removing the prior key and the prior value and releasing their resources.

Optionally, the method further comprises responsive to the first slot comprising a prior value, incrementing the maximum index and updating the slot value.

Optionally, the method further comprises incrementing the maximum index and responsive to a predetermined event, increasing the maximum index.

According to an aspect of some embodiments of the present invention there is provided a non-transitory computer-readable storage medium storing computer-executable instructions that, when executed by a processor, cause the processor to execute a method for data insertion, the method comprising: applying a first hash function associated with a first hash table to the new key to compute a hash value, responsive to existence of a first slot in a bucket associated with an address derived from the hash value, the first slot associated with an invalid integer index, placing the new key and the new value in the first slot, otherwise kicking a key and a value comprising a second slot in the bucket to a third slot, and responsive to the first slot comprising a prior key and a prior value, removing the prior key and the prior value and releasing their resources.

According to an aspect of some embodiments of the present invention there is provided a computer program product comprising computer-executable instructions stored on a non-transitory computer-readable storage medium that, when executed by a processor of a system, cause the system to be configured to apply a first hash function associated with a first hash table to the new key to compute a hash value, responsive to existence of a first slot in a bucket associated with an address derived from the hash value, the first slot associated with an invalid integer index, place the new key and the new value in the first slot, otherwise kick a key and a value comprising a second slot in the bucket to a third slot, and responsive to the first slot comprising a prior key and a prior value, remove the prior key and the prior value and release their resources.

According to an aspect of some embodiments of the present invention there is provided a system comprising a storage, comprising one or more hash tables, each associated with one or more hash functions and comprising a plurality of buckets, each bucket comprising one or more slots, each slot comprising an integer index and a key, a maximum index, and a capacity value, one or more processors configured to perform the following in each of a plurality of iterations performed for insertion of a new key: apply a first hash function associated with a first hash table to the new key to compute a hash value, responsive to existence of a first slot in a bucket associated with an address derived from the hash value, the first slot associated with an invalid integer index, place the new key and the new value in the first slot, otherwise kick a key and a value comprising a second slot in the bucket to a third slot, and responsive to the first slot comprising a prior key and a prior value, remove the prior key and the prior value and release their resources.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE SEVERAL VIEWS OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a class chart of a hot table with automatic garbage collection, according to some embodiments of the invention;

FIG. 2 is a layout of a hot table, according to some embodiments of the invention;

FIG. 3 is an illustration of increasing the capacity of a hot table, according to some embodiments of the invention;

FIG. 4 is an illustration of element insertion workflow, according to some embodiments of the invention;

FIG. 5 is an illustration of multi-copy element retrieval workflow, according to some embodiments of the invention;

FIG. 6 is an illustration of single-copy element retrieval workflow, according to some embodiments of the invention;

FIG. 7 is an example pseudocode listing illustrating element retrieval and deletion functions, according to some embodiments of the invention;

FIG. 8 is a class chart of a hot table with automatic garbage collection, external shifter, and a sorter, according to some embodiments of the invention;

FIG. 9 is an example pseudocode listing illustrating hot table with a metric counter functions, according to some embodiments of the invention.

FIG. 10 is an illustration of element insertion workflow with an external shifter, according to some embodiments of the invention;

FIG. 11 is an illustration of element insertion workflow with a metric counter, according to some embodiments of the invention;

FIG. 12 is an example pseudocode listing illustrating element insertion workflow, according to some embodiments of the invention; and

FIG. 13 is an example pseudocode listing illustrating hot table creation and destruction functions, according to some embodiments of the invention.

### DESCRIPTION OF SPECIFIC EMBODIMENTS OF THE INVENTION

The present invention, in some embodiments thereof, relates to computer science and, more particularly, but not exclusively, to data structure design.

As used herein, the term “hot data” means data should be kept in the data structure according to a retention policy, and, conversely, the term “cold data” means data that should be evicted according to the retention policy.

As used herein, the term “kicking” means the process of displacing an existing element from its current slot in a hash table to an alternative slot, typically to resolve a collision by making room for a new element being inserted into the hash table.

As used herein, the term “victim” means an element that is displaced from its current slot in a hash table during the insertion process, as a result of being evicted to accommodate a new element.

As used herein, the term “LRU” means “Least Recently Used,” a caching algorithm that prioritizes the retention of frequently accessed data by evicting the data item that has not been used for the longest period. This method is beneficial for managing limited cache resources by ensuring that the most recently accessed, and therefore likely most relevant, data remains available. Similarly, the term “LFU” means “Least Frequently Used,” referring to a caching algorithm that evicts data items based on access frequency. LFU prioritizes retention of data that has been accessed most frequently over time, making it suitable for scenarios where frequency of use is a key factor in determining relevance. Both LRU and LFU are commonly employed in memory and cache management, database systems, and similar environments where effective storage management and quick retrieval of high-priority data are critical.

Each of type of data structure has its own advantages and disadvantages. For example, arrays enjoy locality as they are continuous in memory while linked-lists have efficient insertion operation. Efficient data searches can be performed using trees or tries when the preservation of key order is required, such as for sorted queries or prefix-based lookups. However, in cases where key order is not necessary, hash tables typically provide superior performance due to their faster access times. However, hash tables have an inherent shortcoming: as the distribution of keys to addresses is not uniform, multiple keys can receive the same address while other addresses remain empty. There are several common approaches to address this shortcoming: (1) using a linked list at every address to increase flexibility, albeit at the cost of additional memory accesses; (2) using linear probing, where a new key is inserted into the next available address when the initial address is occupied; and (3) using the cuckoo hashing technique which computes two addresses for each element using two distinct hash functions. If both addresses are occupied, the cuckoo hashing technique involves removing an existing key from one of the addresses and attempting to insert it a its alternate location. This process is often referred to as “kicking”. In many implementations, failing to insert the key after a set number of kicks triggers an expensive resize operation of the table.

The method described hereinbelow utilizes the recognition that the kicking process, which efficiently scan through the data, can be used internally to handle data resources and create behaviors for which traditional data structures would require additional management. Storing metadata in slots allows for a mechanic system where the data structure efficiently performs maintenance and correctness operations which in the past required external management and resources. Moreover, storing metadata in and slots allows efficient management of the metadata with memory locality and probabilistic distribution that promises high accuracy and updates. This is achieved by harnessing the dual indices and kicking process to visit multiple addresses and slots in a single operation.

Storing multiple slots in each bucket increases the probability of collisions and overflow of keys in a bucket, but the kicking process balances the address capacity when an address gets more key candidates than it can hold. As a result, each bucket can be treated as an independent small array which can be updated in constant time. Therefore, adding a score, an index, a timestamp or a Boolean flag can enable fine tuning of internal data. It is possible to have dual layers of keys where one is layer comprises a list of candidates that need to reach a predetermined threshold to enter the permanent list.

Common use cases in the industry that can benefit from Hot Tables are cache solutions such as LRU or LFU which have a preset memory allocation or time based list which should expand and contract. Hot Tables can serve as a memory optimized probabilistic data structure for use cases such as approximate membership queries and tracking heavy hitters in streams of data.

In essence, hot tables assign a sequentially increasing index to each new inserted element and track a current maximum index. In conjunction with the configured capacity, this enables hot tables to effectively designate elements possessing a low enough index as cold and evict them as necessary. Hot tables may comprise more than one hash function, each hash function being associated with a same or a distinct hash table, enabling to kick elements from one slot to another as necessary, retaining them in the hot tables.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

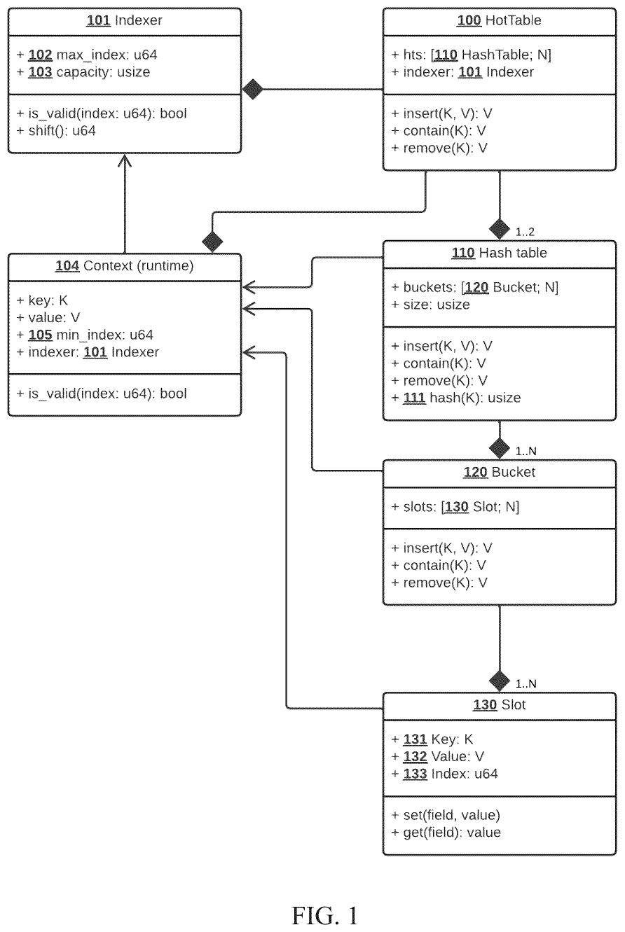

Referring now to the drawings, FIG. 1 is a class chart of a hot table with automatic garbage collection. Optionally, an indexer 101 comprises the maximum index 102 and the capacity 103, the command context 104 comprises the indexer 101 and copies of required variables, and client requests are served via respective class methods. This object-oriented design facilitates modular implementation and maintenance of the hot table data structure.

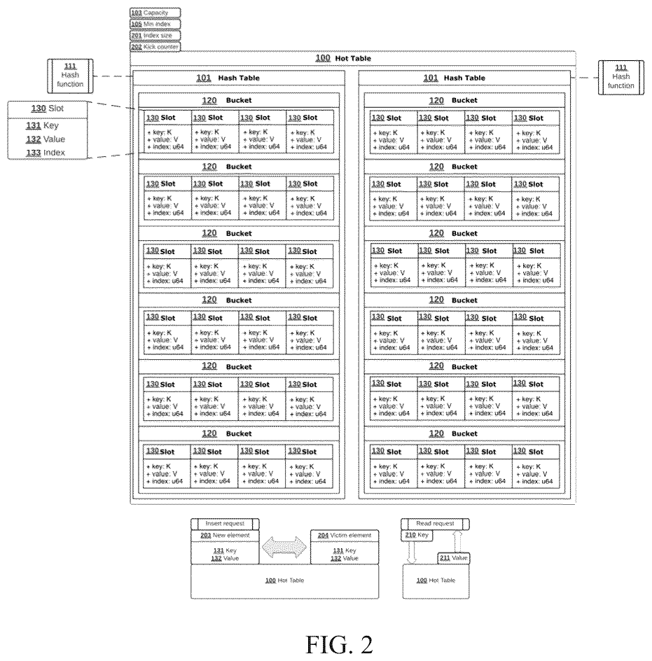

FIG. 2 illustrates the layout of a hot table. Optionally, a hot table 100 comprises one or more hash tables 110, each hash table 110 in turn comprising a plurality of buckets 120. Each bucket 120 is uniquely identified by an address and comprises one of more slots 130. In essence, a hash table 110 comprises a plurality of buckets 120, and the hash value is used to calculate the address of the required bucket.

Optionally, each hash table 110 is associated with a distinct hash function 111. By way of example, a first hash function 111 and a second hash function 111 associated with a first hash table 110 and a second hash table 110 each comprise the same computational routine with a distinct collection of configuration parameters.

Optionally, each hash table 110 is associated with a plurality of hash functions 111. By way of example, a first hash function 111 and a second hash function 111, both associated with a first hash table 110 comprise different computational routines.

Optionally, a slot 130 comprises a key 131, a value 132, and an index 133. Data types of the key 131 and the value 132 may be chosen according to the payload type of the hot table 100, and data type of the index 133 is an integer. The key 131 and the index 133 possess a service function as described hereinbelow, while value 132 is the entry payload data.

Optionally, a slot 130 comprises a key 131 and an index 133.

Optionally, a bucket 120 has the length of 1 and comprises a single slot.

Optionally, responsive to receiving an insert request of a new element 203 comprising a key 131 and a value 132, the hot table 100 increments the maximum index 102 by 1, and applies a first hash function 111 associated with a first hash table 110 to compute a hash value of the key 131 in order to determine the address of a first bucket 120 in the first hash table 110 where the new element 203 shall be inserted. Incrementing the maximum index 102 effectively pushes zero or more slots 130 below the threshold, thereby designating them as cold and preparing them for an eventual eviction.

Optionally, an index 133 is invalid if it is less than the maximum index 102 minus the capacity value 103 or is empty, and is valid otherwise. This mechanism provides an efficient method for identifying and managing cold data without explicit deletion operations.

Optionally, responsive to receiving an insert request of a new element 203 comprising a key 131 and a value 132, the hot table 100 further increments the minimum index 105 by 1 and assigns to the maximum index 102 and the minimum index 105 their respective values modulo an index size 201. For example, the index size 201 may comprise 255, enabling the range of valid indices 133 to be bounded in size by 1 byte. An index 133 is consequently invalid if it is less than the minimum index 105 and greater than the maximum index 102 and the minimum index 105 is greater than the maximum index 102, or if it is less than the minimum index 105 or it is greater than the maximum index 102 and the minimum index 105 is less or equal than the maximum index 102, and is valid otherwise. This circular indexing scheme allows for efficient memory utilization and simplified index management.

Optionally, responsive to determining that a slot 130 within the first bucket 120 is associated with an invalid index 133, the value 132 of the slot 130 is set to the value 132 of the new element 203, the key 131 of the slot 130 is set to the key 131 of the new element 203, and the index 133 of the slot is set to the current maximum index 102 value. This operation effectively replaces cold data with new, hot data.

Optionally, responsive to determining that none of the slots 130 within the first bucket 120 are associated with an invalid index 133, the hot table 100 applies a second hash function 111 associated with a second hash table 110 to compute a hash value of the key 131 to determine the address of a second bucket 120 in the second hash table 110 where the new element 203 shall be inserted. This multi-table approach enhances collision resolution and load balancing.

As used herein, the term “kicking” an element stored in a first slot 130 from a first bucket 120 in first hash table 110 to a second hash table 110 means exchanging the key 131 and the value 132 of the first slot 130 with the key 131 and the value 132 of the new element 203, respectively, transforming it into a victim element 204, and applying a second hash function 111 associated with the second hash table 110 to compute a hash value of the victim key 131 in order to determine the address of a second bucket 120 in the second hash table 110 where the victim element 204 shall be inserted. This kicking mechanism allows eviction of cold data from the hot table 100 and maintenance of metadata with negligible overhead.

As used herein, the term “successful kicking” means determining at least one slot 130 within a second bucket 120 in a second hash table 110 associated with an invalid index 133, setting the key 131 of the slot 130 to the key 131 of the victim element 204, setting the value 132 of the slot 130 to the value 132 of the victim element 204, and setting the index 133 of the slot 130 to the current maximum index 102 value. As used herein, the term “failed kicking” means determining that none of the slots 130 within the second bucket 120 are associated with an invalid index 133. These definitions provide a clear framework for the kicking process and its outcomes.

Optionally, responsive to determining that none of the slots 130 within the first bucket 120 are associated with an invalid index 133, the hot table 100 randomly picks a third slot 130 in the first bucket 120 and kicks it to a second hash table 110, maintaining the current value of the maximum index 102.

Optionally, responsive to determining that none of the slots 130 within any of the buckets 120 in any of the hash tables 110 are associated with an invalid index 133, the hot table 100 increments the maximum index 102. This operation effectively ages the data in the hot table, potentially marking one or more slots as cold and eligible for eviction and replacement in subsequent kicking operations.

Optionally, the hot table 100 iteratively performs kicking during insertion until an iteration of kicking succeeds. This approach ensures that the new data is inserted even when hash tables are almost fully occupied by hot data.

Optionally, the hot table 100 comprises a kick counter 202, a successful kicking resets the kick counter 202 to 0, and a failed kicking increments the kick counter 202 by 1. This mechanism provides a metric for the performance of inserting new elements and may be used to trigger structural changes in the hot table such as reducing the number of hot elements or growing.

Optionally, responsive to the value of the kick counter 202 exceeding a predetermined threshold, the hot table 100 increments the maximum index 102 by 1. Optionally, responsive to the value of the kick counter 202 exceeding a predetermined threshold, the hot table 100 increments the maximum index 102 by a predetermined percentage of the total capacity of the hot table 100. These adaptive incrementing strategies allow for fine-tuned control over the aging process of data in the hot table.

Optionally, a bucket 120 comprises an array of keys 131, an array of values 132 and an array of indices 133, allowing applying vector-based operations or SIMD (Single Instruction, Multiple Data) operations to each of the arrays, rather than operating on individual slots 130 iteratively. This structure enables efficient parallel processing and can significantly improve performance on modern hardware architectures.

Optionally, responsive to receiving a read request of a key 210, the hot table 100 applies a first hash function 111 associated with a first hash table 110 to compute a hash value of the key 210 in order to determine the address of a first bucket 120 in the first hash table 110 where a respective value 211 may be located. Responsive to determining that a slot 130 within the first bucket 120 is associated with a valid index 133, the response value 211 is set to the value 132 of the slot 130. This process enables efficient retrieval of hot data.

Optionally, responsive to receiving a read request of a key 210, the hot table 100 applies a first hash function 111 associated with a first hash table 110 to compute a hash value of the key 210 in order to determine the address of a first bucket 120 in the first hash table 110 where a respective value 211 may be located, and the response value 211 is set to the value 132 of the slot 130. This process enables retrieval of data regardless of its hot or cold status.

Optionally, responsive to determining that a slot 130 within the first bucket 120 is associated with an invalid index 133, the hot table 100 evicts the data, enabling potential conservation of memory at the expense of lower read performance. This lazy eviction strategy can help balance memory usage and read performance based on specific application requirements.

Optionally, responsive to determining that none of the slots 130 within a first bucket 120 are associated with a valid index 133, the hot table 100 applies a second hash function 111 associated with a second hash table 110 to compute a hash value of the key 210 in order to determine the address of a second bucket 120 in the second hash table 110 where a respective value 211 may be located. Responsive to determining that a slot 130 within the second bucket 120 is associated with a valid index 133, the response value 211 is set to the value 132 of the slot 130. This multi-table lookup strategy is often more efficient than hash tables which are based on linked lists as there are less dereferencing of pointers.

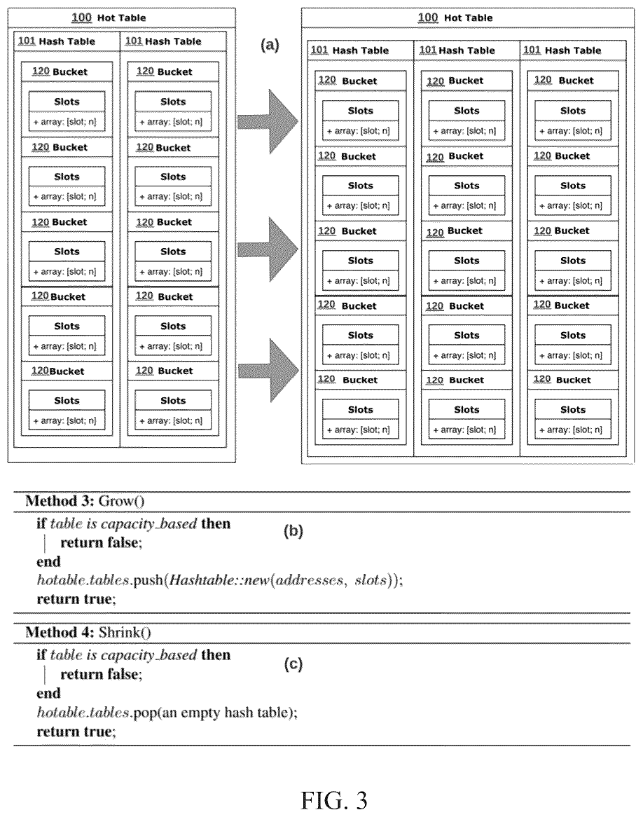

FIG. 3 illustrates increasing the capacity of a hot table 100. Optionally, responsive to a first predetermined condition being met, a hot table 100 grows by allocating an additional empty hash table 110 and an associated hash function 111. This dynamic growth capability enables the hot table to adapt to increasing data loads. The new size of the hash table may be determined according to the different policies such as analyzing velocity of incoming stream of elements. An example layout of a hot table 100 before and after growth is illustrated in FIG. 3(a).

Optionally, a hot table 100 grows by allocating a new hash table 110 with a new associated hash function 111, utilizing the new associated hash function 111 to insert each element stored in the existing hash table 110 into the new hash table 110 and deleting the existing hash table 110. An example method of growing a hot table 100 is illustrated in FIG. 3(b). The method makes a determination of whether a hot table 100 is capacity-based and may not have its size modified, otherwise the method allocates a new hash table 110 of a predetermined number of buckets 120, each bucket identified by an address and comprising a predetermined number of slots 130.

Optionally, responsive to a predetermined condition being met, a hot table 100 shrinks by destroying an existing empty hash table 110 and an associated hash function 111. This dynamic shrinking capability enables efficient memory utilization responsive to decreasing data loads. An example method of shrinking a hot table 100 is illustrated in FIG. 3(c). The method makes a determination of whether a hot table 100 is capacity-based and may not have its size modified, otherwise queries the hot table 100 for existence of an empty hash table 110 and destroys one if found.

Optionally, growing or shrinking a first hot table 100 is performed by creating a new hot table 100 of a desired capacity 103, operating both hot table 100 instances synchronously while only executing writes into the new hot table 100, and deleting the first hot table 100 responsive to a determination being made that each element stored therein is cold.

Optionally, responsive to a predetermined condition being met, a hot table 100 kicks all hot elements from a hash table 110 to other hash tables 110 in the hot table. This operation can be used to prepare a hash table for removal.

Optionally, responsive to a predetermined condition being met, a hot table 100 marks a hash table 110 as inadmissible for new data insertion. This enables the hot table 100 to safely destroy the hash table 110 as soon as all the data stored in it qualifies as cold.

Optionally, the predetermined condition for growing a hot table 100 comprises the kick counter 202 exceeding a predetermined threshold value. This adaptive growth strategy ensures that the hot table expands when insertion operations become consistently difficult.

Optionally, a hot table 100 may initialize with a surplus capacity comprising a predetermined percentage of the total capacity 103, enabling prevention of excessive kicking or growth and improving performance. This proactive capacity allocation can help maintain consistent performance under varying load conditions.

Optionally, a hot table 100 may initialize with one hash table 110 comprising a predetermined percentage of the total capacity 103, enabling conservation of memory during early operation and allocating additional hash tables 110 on the fly. This strategy allows for efficient memory usage in scenarios where the initial data load is uncertain.

Optionally, a hot table 100 may comprise a plurality of hash tables 110, wherein the pluralities of buckets 120 of at least two hash tables 110 differ in size. In one example, a first hash table 110 comprises 90% of the total capacity 103, and a second hash table 110 comprises 10% of the total capacity 103. Such a configuration maintains a high fill rate through the kicking process, with the majority of insertion operations performed at addresses identified by the hash values of keys 131 computed by applying a first hash function 111 associated with the first hash table 110. In another example, growing or shrinking of the hot table 100 may be performed by allocating a new hash table 110 comprising a plurality of buckets 120 of a desired size, disabling execution of writes into an existing hash table 110, and subsequently deleting the existing hash table 110 responsive to a determination being made that each element stored therein is cold.

Optionally, a hot table 100 may comprise a plurality of hash tables 110, wherein the pluralities of slots 130 of buckets 120 of at least two hash tables 110 differ in size. In an example, a first hash table 110 may comprise a plurality of buckets 120, each bucket 120 comprising 8 slots, and a second hash table 110 may comprise a plurality of buckets 120, each bucket 120 comprising 2 slots.

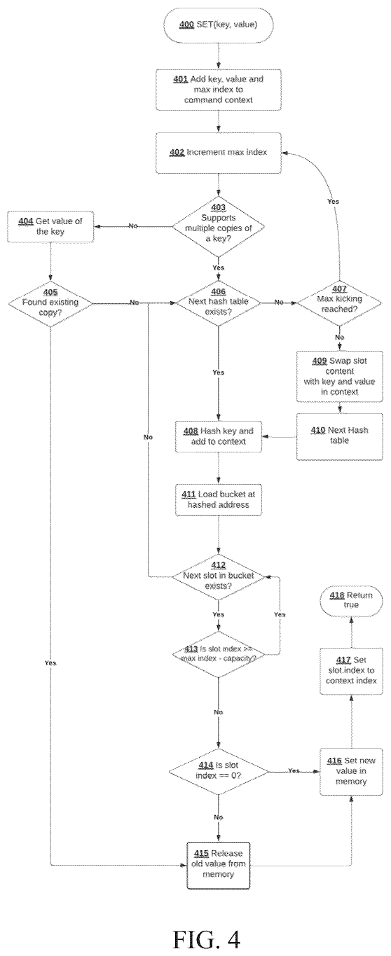

FIG. 4 illustrates the element insertion workflow. Optionally, the method of executing a SET command begins at an initial step 400 and proceeds through the following key steps.

At step 401, the hot table 100 adds a key 131, a value 132 and a maximum index 102 to the command context 104, making shallow copies or taking ownership of these variables available to actions performed in subsequent steps.

At steps 402-413 the process locates a slot 130 available for insertion of new data. At the step 402 the hot table 100 increments the maximum index 102, potentially deeming zero or more slots 130 as cold, and allowing the contents of the slots 130 to be released and overwritten.

Next, the process proceeds to a decision step 403. At the step 403 a determination is made as to whether the hot table 100 is configured to support multiple slots 130 in a bucket 120 corresponding to a same key 131 hash. If true, the process proceeds to a decision step 406. If false, the process proceeds to a step 404.

At the step 404 the hot table 100 executes a GET command to find out whether hash table 110 contains the key 131.

Next, the process proceeds to a decision step 405. At the step 405 a determination is made as to whether the key 131 has been found. If false, the process proceeds to the decision step 406. If true, the process proceeds to a step 415 where the value and other metadata is updated.

At the step 406 a determination is made as to whether there are any unchecked hash tables 110 remaining in the hot table 100 at the current value of maximum index 102. If there is no unchecked hash table 110 remaining, the process proceeds to a decision step 407. If there is an unchecked hash table 110 remaining, the process proceeds to a step 405 to check the hash table 110.

At the step 407 a determination is made as to whether the number of kicks executed during the insertion process exceeds the maximum kick counter 202. If the number of executed kicks exceeds the maximum kick counter 202, the process returns to the step 402, otherwise the process proceeds to a step 409.

At the step 409 the hot table swaps key 131 and value 132 of a currently examined slot 130 with key 131 and value 132 in the command context 104. This effectively kicks the element stored in the currently examined slot 130 and replaces it with the element in the command context 104.

Next, the process proceeds to a step 410. At the step 410 the hot table 100 switches to a next hash table 110, or to a next hash function 111 associated with the hash table 110. Next, the process proceeds to the step 408.

At the step 408 the hot table 100 applies a respective hash function 111 associated with the hash table 110 to compute a hash value of the key 131 and adds it to the command context 104.

Next, the process proceeds to a step 411. At the step 411 the hot table 100 loads slots 130 from a bucket 120 at the address identified by the hash value of the key 131.

Next, the process proceeds to a decision step 412. At the step 412 a determination is made as to whether there are any unchecked slots 130 remaining in the bucket 120. If there is no unchecked slot 130 remaining, the process returns to the step 406. If there is an unchecked slot 130 remaining, the process proceeds to a decision step 413 to check the slot 130. In essence, the process iterates over all slots 130 in the bucket 120.

At the decision step 413 a determination is made as to whether an index 133 of the slot 130 is greater or equal than the maximum index 102 minus the capacity 103. This enables the hot table 100 to determine whether the slot 130 is hot and cannot be overwritten. If true, the process returns to the step 412. If false, the process proceeds to a decision step 414.

At the decision step 414 a determination is made as to whether an index 133 of the slot 130 is equal to zero. Optionally, the special index value of zero denotes an unused slot 130. If the index 133 is not equal to zero, the process proceeds to a step 415. If the index 133 is zero, the process proceeds to a step 416.

At the step 415 the hot table 100 releases an old value and reclaims the previously allocated memory. This step ensures that memory leaks do not occur as a result of overwriting a slot value with new data. Next, the process proceeds to the step 416.

At the step 416, the hot table 100 records the new value 132 to memory.

Next, the process proceeds to a step 417. At the step 417, the hot table 100 records the index 133 of the slot 130 to the command context 104. This step enables determining the validity of the index 133 of the slot 130.

Next, the process proceeds to a terminal step 418. At this point, the process returns to another software routine, reporting that the key 131 has been successfully inserted with a value 132.

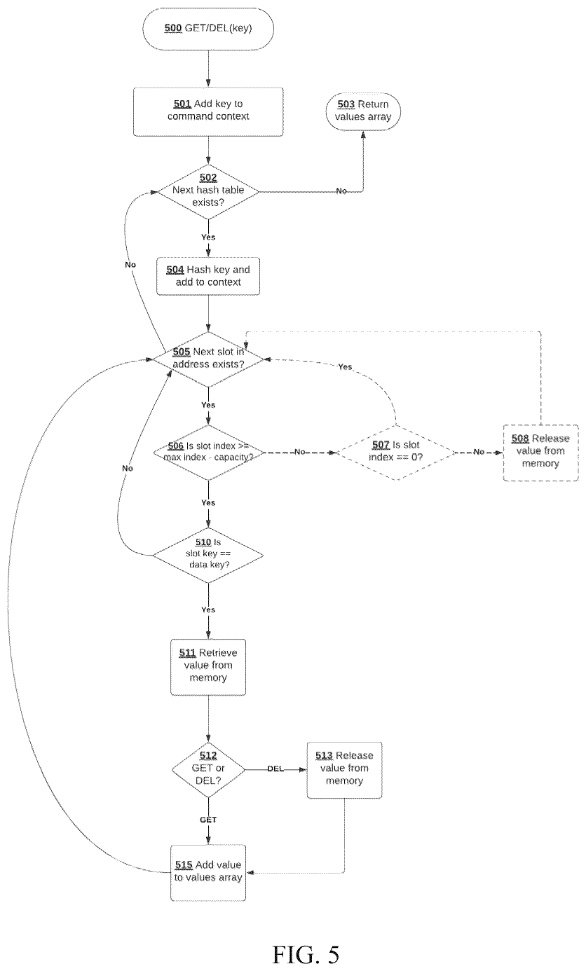

FIG. 5 illustrates the multi-copy element retrieval workflow. According to some embodiments of the invention, the method of executing a GET or a DEL command begins at an initial step 500 and proceeds through the following key steps.

At step 501, the hot table 100 adds the key 210 to the command context 104, making a shallow copy of this variable available to calculations performed in subsequent steps.

Next, the process proceeds to a step 502. At the step 502 a determination is made as to whether there are any unchecked hash tables 110 remaining in the hot table 100. If there is no unchecked hash table 110 remaining, the process proceeds to a step 503. If there is an unchecked hash table 110 remaining, the process proceeds to a step 504 to check the hash table 110.

At the step 503 the hot table returns an array of hot values. At steps 504-515 the method populates the array of values with values 211 appropriately retrieved from memory.

At the step 504 the hot table 100 applies a respective hash function 111 associated with the hash table 110 to compute a hash value of the key 210 and adds it to the command context 104.

Next, the process proceeds to a decision step 505. At the step 505 a determination is made as to whether there are any unchecked slots 130 remaining in the bucket 120. If there is no unchecked slot 130 remaining, the process returns to the step 502. If there is an unchecked slot 130 remaining, the process proceeds to a decision step 506 to check the slot 130.

At the decision step 506 a determination is made as to whether an index 133 of the slot 130 is greater or equal than the maximum index 102 minus the capacity 103. This enables the hot table 100 to determine whether the slot 130 is hot and cannot be overwritten. If false, the process returns to the step 505. Optionally, if false, the process proceeds to a decision step 507.

If true, the process proceeds to a decision step 510.

Optionally, at the decision step 507 a determination is made as to whether an index 133 of the slot 130 is equal to zero. If the index 133 is not equal to zero, the process proceeds to a step 508. If the index 133 is equal to zero, the process returns to the step 505.

Optionally, at the step 508 the hot table 100 releases the recorded value and reclaims the previously allocated memory. This step enables cleanup of cold data that is subject to eviction. Next, the process returns to the step 505.

At the decision step 510 a determination is made as to whether the key 131 of the slot 130 is equal to the requested key 210. If equal, the process proceeds to a step 511. If not equal, the process returns to the step 505. This step enables the method to identify a slot 130 that shall be retrieved and returned.

At the step 511 the hot table 100 retrieves a value 211 from memory.

Next, the process proceeds to a decision step 512. At the decision step 512 a determination is made as to whether the command executed by the method is a GET command or a DEL command. If the command executed is a DEL command, the process proceeds to a step 513. If the command executed is a GET command, the process proceeds to a step 515.

At the step 513 the hot table 100 releases the recorded value and reclaims the previously allocated memory. Next, the process proceeds to the step 515.

At the step 515 the hot table 100 adds the retrieved value 211 to a return array. This enables the hot table 100 to return multiple values stored in a plurality of hash tables 110 identified by a same key 210. Next, the process returns to the step 505.

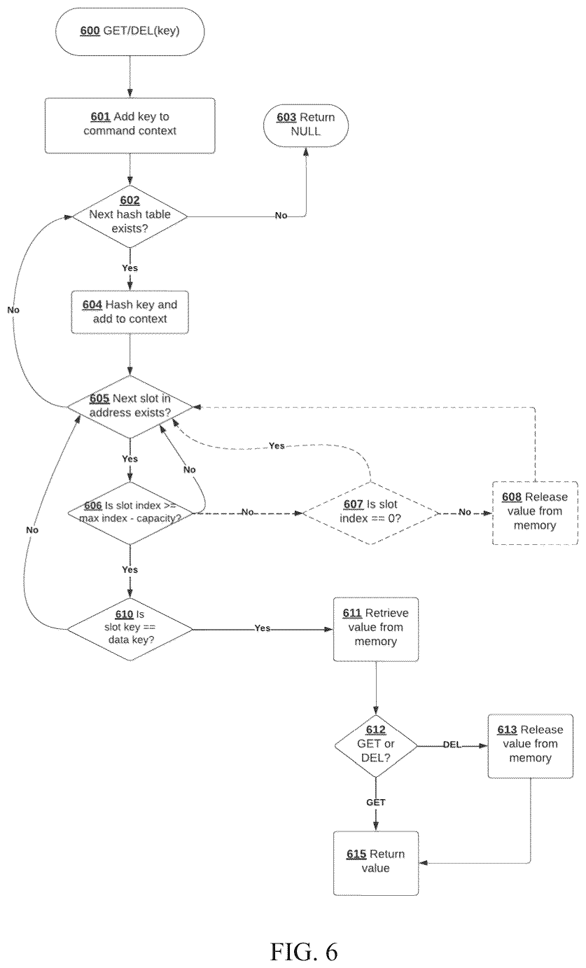

FIG. 6 illustrates the single-copy element retrieval workflow. This optimized version of the retrieval process follows a similar pattern to the multi-copy version but is designed for improved memory efficiency. This single-copy approach can offer performance benefits in scenarios where only a single key is stored in the hot table 100 and insertion of an identical key will swap the old value with the new value and update metadata.

At step 601, the hot table 100 adds the key 210 to the command context 104, making a copy of this variable available to calculations performed in subsequent steps.

Next, the process proceeds to a step 602. At the step 602 a determination is made as to whether there are any unchecked hash tables 110 remaining in the hot table 100. If there is no unchecked hash table 110 remaining, the process proceeds to a step 603. If there is an unchecked hash table 110 remaining, the process proceeds to a step 604 to check the hash table 110.

At the step 603 the hot table 100 returns a null value, indicating that a corresponding value 211 is not found for the requested key 210. At steps 604-615, the method searches for a value 211 corresponding to the requested key 210.

At the step 604 the hot table 100 applies a respective hash function 111 associated with the hash table 110 to compute a hash value of the key 210 and adds it to the command context 104.

Next, the process proceeds to a decision step 605. At the step 605 a determination is made as to whether there are any unchecked slots 130 remaining in the bucket 120. If there is no unchecked slot 130 remaining, the process returns to the step 602. If there is an unchecked slot 130 remaining, the process proceeds to a decision step 606 to check the slot 130.

At the decision step 606 a determination is made as to whether an index 133 of the slot 130 is greater or equal than the maximum index 102 minus the capacity 103. This enables the hot table 100 to determine whether the slot 130 is hot and cannot be overwritten. If false, the process returns to the step 605. Optionally, if false, the process proceeds to a decision step 607.

If true, the process proceeds to a decision step 1010.

Optionally, at the decision step 607 a determination is made as to whether an index 133 of the slot 130 is equal to zero. If the index 133 is not equal to zero, the process proceeds to a step 608. If the index 133 is equal to zero, the process returns to the step 605.

Optionally, at the step 608 the hot table 100 releases the recorded value and reclaims the previously allocated memory. This step enables cleanup of cold data that is subject to eviction. Next, the process returns to the step 605.

At the decision step 610 a determination is made as to whether the key 131 of the slot 130 is equal to the requested key 210. If equal, the process proceeds to a step 611. If not equal, the process returns to the step 605. This step enables the method to identify a slot 130 that shall be retrieved and returned.

At the step 611 the hot table 100 retrieves a value 211 from memory.

Next, the process proceeds to a decision step 612. At the decision step 612 a determination is made as to whether the command executed by the method is a GET command or a DEL command. If the command executed is a DEL command, the process proceeds to a step 613. If the command executed is a GET command, the process proceeds to a step 615.

At the step 613 the hot table 100 releases the recorded value and reclaims the previously allocated memory. Next, the process proceeds to the step 615.

At the step 615 the hot table 100 returns the retrieved value 211.

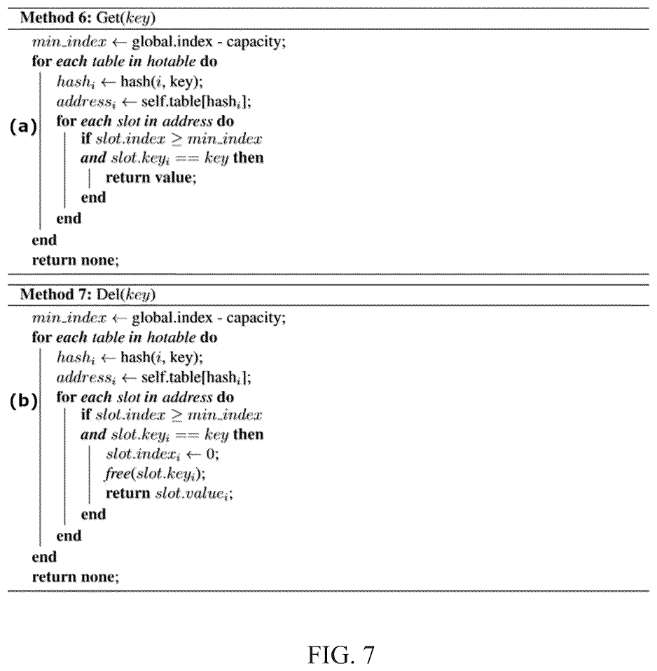

This workflow allows for efficient retrieval and optional deletion of elements, while also performing cleanup of cold data encountered during the process. An example method of element retrieval (GET command) is illustrated in FIG. 7(a), and an example method of element deletion (DEL command) is illustrated in FIG. 7(b). These example methods differ from the workflow disclosed hereinabove in that the determination of the command type is not made, and the command type is assumed to be known in advance.

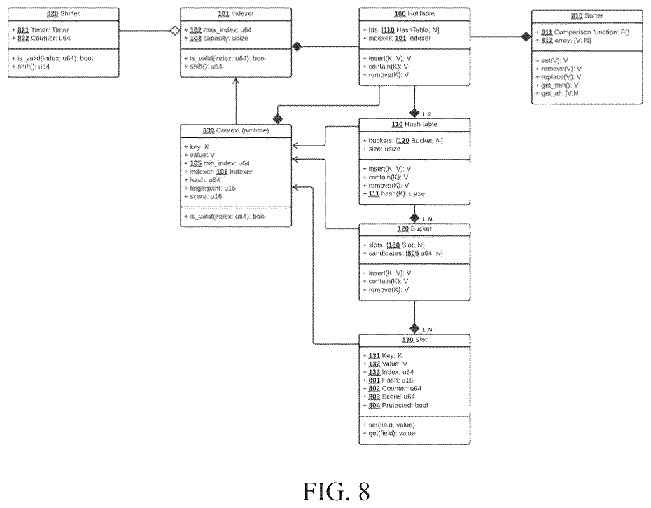

FIG. 8 is a class chart of a hot table with automatic garbage collection, external shifter, and a sorter. Optionally, this enhanced version of the hot table includes:

1. A bucket 120 further comprising a plurality of candidate hash values 805.

2. A slot 130 further comprising at least one of a hash value 801, a counter 802, a score 803, and a eviction protection flag 804.

3. A sorter 810 comprising a comparison function 811 and a top-k array 812, storing a predetermined number of elements possessing a k-highest or a k-lowest value of counter 802 or score 803 as determined by the comparison function 811.

The addition of a counter and a scorer allow for more sophisticated data management and retention policies, such as maintaining most frequently accessed or highest-scoring elements.

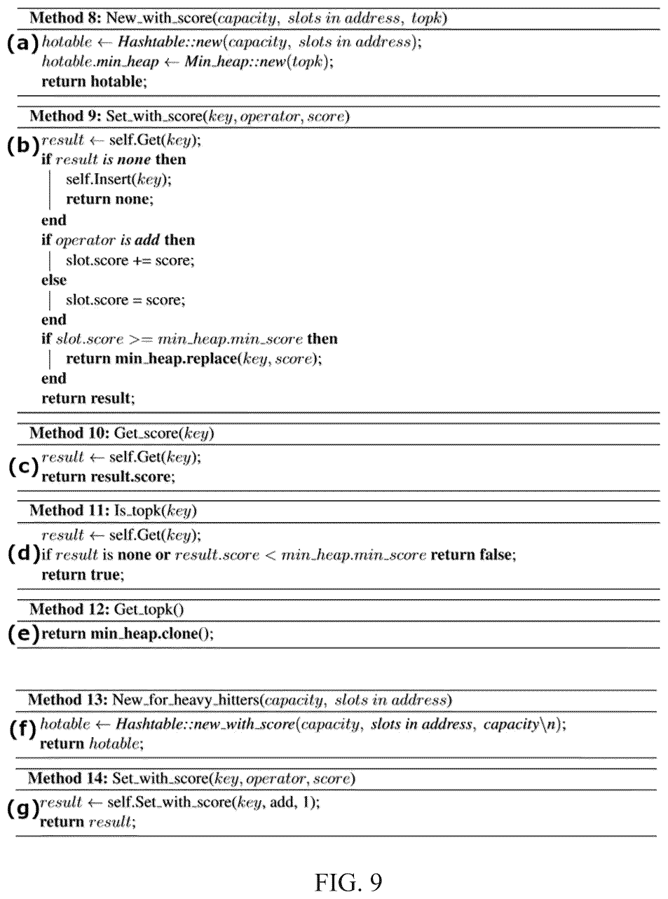

An example method of initializing a hot table 100 with a top-k array 812 is illustrated in FIG. 9(a). The top-k array 812 comprises a min-heap data structure of a size determined by an argument of the method.

An example method of inserting an element with an arbitrary score tracking function is illustrated in FIG. 9(b). The method alternatively supports direct score specification or additive score specification, and maintains a tracker of the minimum score 803 of keys 131 stored in the hot table 100.

Optionally, the hot table 100 performs gatekeeping before inserting a new element 203 comprising a key 131, the gatekeeping comprising: applying a first hash function 111 associated with a first hash table 110 to compute a first hash value of the key 131 and to determine the address of a bucket 120, and checking at least one of allowance conditions, the conditions comprising: (a) determining availability of empty or cold slots 130 in the bucket 120 and (b) querying the plurality of candidate hash values 805 in the bucket 120 for the existence of the first hash value. Responsive to determining that at least one of the conditions is satisfied, the hot table 100 proceeds with the insertion method, and otherwise aborts the insertion method. In an example, such an approach mimics utilization of a set membership probabilistic data structure, and enables avoiding insertion of rare keys into the hot table 100. An example method of element score retrieval is illustrated in FIG. 9(c).

Optionally, the hot table 100 is configured to calculate and publish changes in the list of keys in the top-k array 812.

An example method of testing a key for presence in the top-k array 812 is illustrated in FIG. 9(d). The method determines whether a key 131 is present in the hot table 100, and whether a score 803 is less than the minimum tracked score. An example method of retrieving the entirety of the top-k array 812 is illustrated in FIG. 9(e).

An example method of initializing a hot table 100 and tracking heavy hitter elements is illustrated in FIG. 9(f). The method wraps a method of initializing a hot table with a top-k array by specifying the size of the top-k array 812 to be equal to the capacity of the hot table 100.

An example method of inserting an element with a counter is illustrated in FIG. 9(g). The method wraps a method of inserting an element with an arbitrary score tracking function by utilizing additive score specification and a constant additional score of 1. This enables support for the special case wherein the hot table 100 tracks an insertion counter 802 for each key 131.

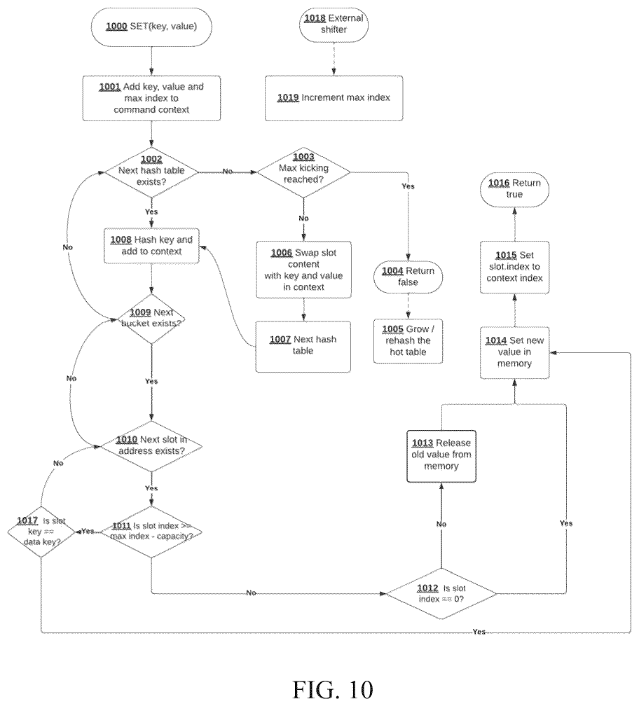

FIG. 10 illustrates the element insertion workflow with an external shifter. This workflow introduces additional complexity to enable external software components to exert control over the pace of element eviction from the hot table.

At step 1001 the hot table 100 adds the key 131, the value 132 and maximum index 102 to the command context 104, making copies of these variables available to calculations performed in subsequent steps.

Next, the process proceeds to a decision step 1002. At the step 1002 a determination is made as to whether there are any unprocessed hash tables 110 remaining in the hot table 100.

If there is no unprocessed hash table 110 remaining, the process proceeds to a step 1003. If there is an unprocessed hash table 110 remaining, the process proceeds to a step 1008 to process the hash table 110.

At the step 1007 a determination is made as to whether the number of kicks executed during the insertion process exceeds the maximum kick counter 202. If the number of executed kicks exceeds the maximum kick counter 202, the process proceeds to a step 1004, otherwise the process proceeds to a step 1006.

At the step 1006 the hot table swaps key 131 and value 132 of a currently examined slot 130 with key 131 and value 132 in the command context 104. This effectively kicks the element stored in the currently examined slot 130 and replaces it with the element in the command context 104.

Next, the process proceeds to a step 1007. At the step 1007 the hot table 100 switches to a next hash table 110, or to a next hash function 111 associated with the hash table 110. Next, the process proceeds to the step 1008. At the step 1004 the hot table 100 returns false, signifying a failure of the insertion process. This in turn triggers execution 805 of a growth or rehashing procedure for the hot table 100.

At the step 1008 the hot table 100 applies a respective hash function 111 associated with the hash table 110 to compute a hash value of the key 131 and adds it to the command context 104.

Next, the process proceeds to a decision step 1009. At the step 1009 a determination is made as to whether there are any unprocessed buckets 120 remaining in the hash table 110. If there is no unprocessed bucket 120 remaining, the process returns to the step 1002. If there is an unprocessed bucket 120 remaining, the process proceeds to a step 1010 to process the bucket 120.

At the step 1010 a determination is made as to whether there are any unprocessed slots 130 remaining in the bucket 120. If there is no unprocessed slot 130 remaining, the process returns to the step 1009. If there is an unprocessed slot 130 remaining, the process proceeds to a step 1011.

At the decision step 1011 a determination is made as to whether an index 133 of the slot 130 is greater or equal than the maximum index 102 minus the capacity 103. This enables the hot table 100 to determine whether the slot 130 is hot and cannot be overwritten. If false, the process proceeds to a decision step 1012. If true, the process proceeds to a decision step 1017.

At the decision step 1012 a determination is made as to whether an index 133 of the slot 130 is equal to zero. If the index 133 is not equal to zero, the process proceeds to a step 1013. If the index 133 is equal to zero, the process proceeds to a step 1014.

At the step 1013 the hot table 100 releases an old value and reclaims the previously allocated memory. This step ensures that memory leaks do not occur as a result of overwriting a slot value with new data.

At the step 1014, the hot table 100 records the new value 132 to memory.

Next, the process proceeds to a step 1015. At the step 1015, the hot table 100 records the index 133 of the slot 130 to the command context 104. This step enables determining the index 133 of the evicted slot 130.

Next, the process proceeds to a terminal step 1016. At this point, the process returns to another software routine, reporting that the value 132 has been successfully inserted with a key 131.

At the decision step 1017 a determination is made as to whether the key 131 of the slot 130 is equal to the new key 131. If equal, the process proceeds to the step 1014 to overwrite the value associated with the new key 131. If not equal, the process returns to the step 1010. Step 1017 provides an optimization for updating existing keys.

Optionally, a hot table 100 may use a hash value 801 in the slot 130 for comparison purposes against a hash of the new key 131. This approach reduces dereferences of pointers and enables a faster comparison.

Optionally, a hash value 801 may comprise a partial hash, or a fingerprint, of a hash of a key 131. This approach enables considerable memory savings.

Optionally, a slot 130 consists of a hash value 801 and an index 133. For example, a hot table 100 utilizing such slots may serve as a fast Approximate Membership Query data structure, each slot 130 consuming 2 bytes per element.

Optionally, a slot 130 comprises a hash value 801 and does not comprise a key 131, and kicking a victim element 204 from a first bucket 120 in first hash table 110 to a second hash table 110 comprises applying a second hash function 111 associated with the second hash table 110 to compute a hash value based on the hash value 801 of the victim and the address of the first bucket 120.

Optionally, a slot 130 does not comprise a value 132, and the hot table 100 serves for score or count tracking purposes.

Optionally, an external shifter 818 triggers an increase 819 of the maximum index. This enables an external software component to control expiration of data and effectively designate slots 130 as cold periodically, episodically or responsive to a predetermined event. The external shifter mechanism enables flexible external control over data aging and eviction via triggers or timers.

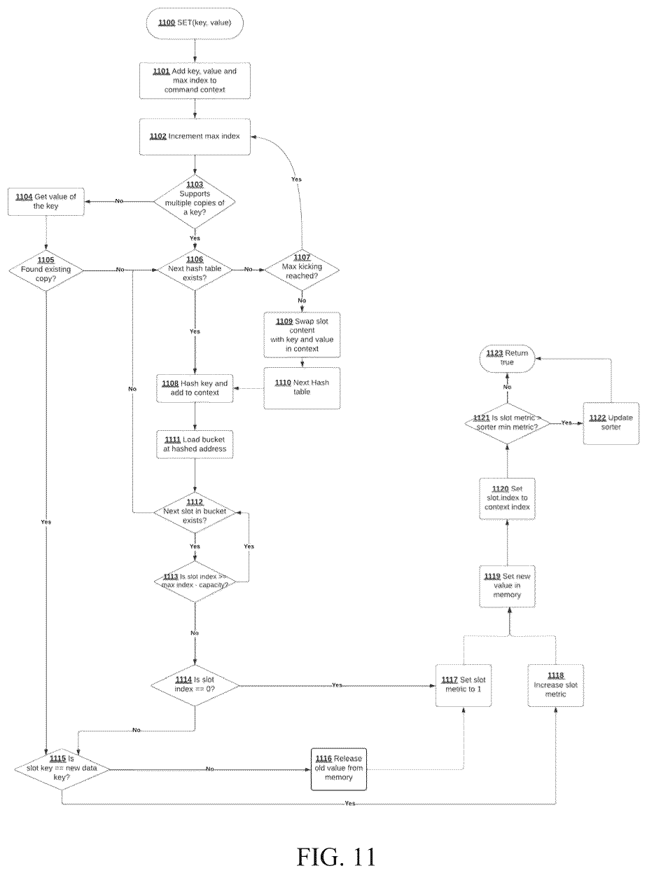

FIG. 11 illustrates the element insertion workflow with a metric counter. This workflow incorporates counter-based or score-based metrics into the insertion process.

The addition of metric counters allows for more nuanced data management strategies, such as keeping track of access frequency or other custom metrics. These workflows demonstrate the flexibility and power of the hot table data structure, allowing for efficient management of hot and cold data with various optimizations for different use cases and performance requirements.

Optionally, the metric comprises a counter 802 and increasing the metric comprises incrementing the counter 802 by 1. This simple counting mechanism can be used to track data update rates or other cumulative metrics.

Alternatively, the metric comprises a score 803 and increasing the metric comprises adding to the score 803 a new score value passed as an argument to the SET method. This more flexible scoring system allows for custom weighting of different operations or data characteristics.

At a step 1101, the hot table 100 adds the key 131, the value 132 and maximum index 102 to the command context 104, making copies of these variables available to calculations performed in subsequent steps.

Next, the process proceeds to a step 1102. At the step 1102 the hot table 100 increments the maximum index 102. This potentially marks zero or more slots 130 as cold, allowing the contents of the slots 130 to be overwritten.

Next, the process proceeds to a decision step 1103. At the step 1103 a determination is made as to whether the hot table 100 is configured to support multiple slots 130 in a bucket 120 corresponding to a same key 131 hash. If true, the process proceeds to a decision step 1106. If false, the process proceeds to a step 1104.

At the step 1104 the hot table 100 retrieves from a currently examined hash table 110 the key 131.

Next, the process proceeds to a decision step 1105. At the step 1105 a determination is made as to whether a copy of the key 131 has been found. If false, the process proceeds to the decision step 1106. If true, the process proceeds to a decision step 1115.

At the step 1106 a determination is made as to whether there are any unchecked hash tables 110 remaining in the hot table 100 at the current value of maximum index 102. If there is no unchecked hash table 110 remaining, the process proceeds to a decision step 1107. If there is an unchecked hash table 110 remaining, the process proceeds to a step 1108 to check the hash table 110.

At the step 1107 a determination is made as to whether the number of kicks executed during the insertion process exceeds the maximum kick counter 202. If the number of executed kicks exceeds the maximum kick counter 202, the process returns to the step 1102, otherwise the process proceeds to a step 1109.

At the step 1109 the hot table swaps key 131 and value 132 of a currently examined slot 130 with key 131 and value 132 in the command context 104. This effectively kicks the element stored in the currently examined slot 130 and replaces it with the element in the command context 104.

Next, the process proceeds to a step 1110. At the step 1110 the hot table 100 switches to a next hash table 110, or to a next hash function 111 associated with the hash table 110. Next, the process proceeds to the step 1108.

At the step 1108 the hot table 100 applies a respective hash function 111 associated with the hash table 110 to compute a hash value of the key 131 and adds it to the command context 104.

Next, the process proceeds to a step 1111. At the step 1111 the hot table 100 loads slots 130 from a bucket 120 at the address identified by the hash value of the key 131.

Next, the process proceeds to a decision step 1112. At the step 1112 a determination is made as to whether there are any unchecked slots 130 remaining in the bucket 120. If there is no unchecked slot 130 remaining, the process returns to the step 1106. If there is an unchecked slot 130 remaining, the process proceeds to a decision step 1113 to check the slot 130.

At the decision step 1113 a determination is made as to whether an index 133 of the slot 130 is greater or equal than the maximum index 102 minus the capacity 103. This enables the hot table 100 to determine whether the slot 130 is hot and cannot be overwritten. If true, the process returns to the step 1112. If false, the process proceeds to a decision step 1114.

At the decision step 1114 a determination is made as to whether an index 133 of the slot 130 is equal to zero. Optionally, the special index value of zero denotes an unused slot 130.

If the index 133 is not equal to zero, the process proceeds to a step 1115. If the index 133 is zero, the process proceeds to a step 1117.

At the decision step 1115 a determination is made as to whether the key 131 of the slot 130 is equal to the new key 131. If equal, the process proceeds to a step 1118. If not equal, the process proceeds to the step 1116.

At the step 1116 the hot table 100 releases an old value and reclaims the previously allocated memory.

At the step 1117 the hot table sets a metric of the slot 130 to one or other value according to a policy.

At the step 1118 the hot table increases the metric of the slot 130.

Next, the process proceeds to a step 1119. At the step 1119, the hot table 100 records the new value 132 to memory.

Next, the process proceeds to a step 1120. At the step 1120, the hot table 100 records the index 133 of the slot 130 to the command context 104. This step enables determining the index 133 of the evicted slot 130.

Next, the process proceeds to a decision step 1121. At the step 1121, a determination is made as of whether the metric of the slot 130 exceeds the respective threshold metric in the sorter 810. If true, the process proceeds to a step 1122. If false, the process proceeds to a terminal step 1123.

At the step 1122, the hot table 100 performs an update call of the sorter 810, recording the key 131 and the metric of the slot 130 to the top-k array 812. Next, the process proceeds to the terminal step 1123.

At this point, the process returns to another software routine, reporting that the value 132 has been successfully inserted with a key 131.

Optionally, a check of a key 131 against a new key 131 further comprises a check of a slot hash value 801 against a hash of the new value 132, performed in advance of the original check of the key 131 against the new key 131. This hash-based pre-check can significantly improve performance by quickly ruling out non-matching slots without performing a full key comparison.

Optionally, the hot table 100 is configured to automatically apply a first set of instructions to keys added to the top-k array 812 and a second set of instructions to keys dropped from the top-k array 812 upon a shifter execution step. This feature enables automatic handling of high-priority or frequently accessed data by an external software routine, potentially triggering caching mechanisms or other optimizations.

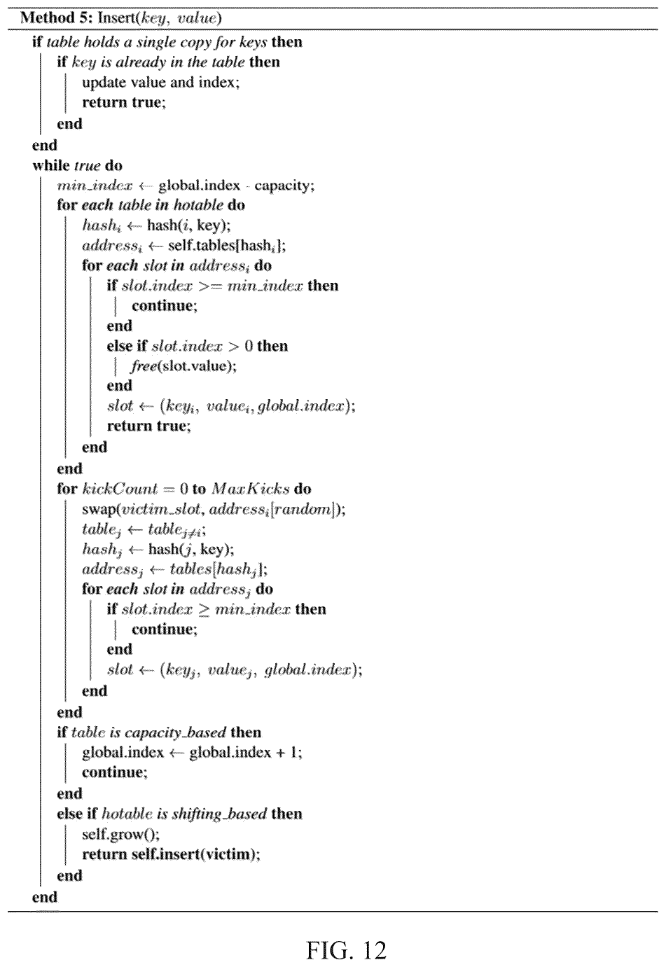

An example element insertion method supporting a single-copy and a multi-copy mode of operations is illustrated in FIG. 12. This example method differs from the workflow disclosed hereinabove in that the method supports multi-copy and single-copy workflows, support for a capacity-based hot table 100 and a hot table 100 with an external shifter 818, and comprises a generalization of methods disclosed hereinabove.

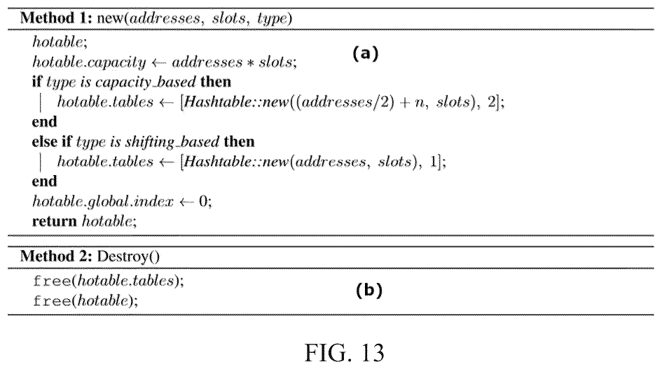

An example method of initializing a new hot table 100 of a desired capacity comprising two hash tables 110 or a new hot table 100 with an external shifter 818 as specified by an argument is illustrated in FIG. 13(a). An example method of destroying an existing hot table 100 and reclaiming its resources is illustrated in FIG. 13(b).

The terms “comprises”, “comprising”, “includes”, “including”, “having” and their conjugates mean “including but not limited to”.

The term “consisting of” means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

It is the intent of the Applicant(s) that all publications, patents and patent applications referred to in this specification are to be incorporated in their entirety by reference into the specification, as if each individual publication, patent or patent application was specifically and individually noted when referenced that it is to be incorporated herein by reference. In addition, citation or identification of any reference in this application shall not be construed as an admission that such reference is available as prior art to the present invention. To the extent that section headings are used, they should not be construed as necessarily limiting. In addition, any priority document(s) of this application is/are hereby incorporated herein by reference in its/their entirety.

What is claimed is:

1. A system comprising:
a storage comprising:
one or more hash tables, each associated with one or more hash functions and comprising a plurality of buckets, each bucket comprising one or more slots, each slot comprising:
an integer index;
a key; and
a value;
a maximum index; and
a capacity value;
one or more processors configured to perform the following in each of a plurality of iterations performed for insertion of a new key associated with a new value:
apply a first hash function associated with a first hash table to the new key to compute a hash value;
responsive to existence of a first slot in a bucket associated with an address derived from the hash value, the first slot associated with an invalid integer index, place the new key and the new value in the first slot, otherwise kick a key and a value comprising a second slot in the bucket to a third slot; and
responsive to the first slot comprising a prior key and a prior value, remove the prior key and the prior value and release their resources.

2. The system according to claim 1, wherein kicking a key and a value comprises:
applying one of a second hash function associated with a second hash table or a third hash function associated with the first hash table to the key to compute a second hash value;
responsive to a slot in a bucket associated with an address derived from the second hash value and an invalid integer index comprising a prior key and a prior value, kicking the prior key and the prior value to a third slot; and
responsive to a predetermined event, associating the one or more hash tables with new hash functions and rehashing the one or more hash tables.

3. The system according to claim 1, wherein the one or more processors are further configured to perform the following:
allocate an additional empty hash table; or
destroy an existing empty hash table.

4. The system according to claim 2, further comprising a programmatic interface enabling external manipulation of the maximum index, and wherein responsive to a predetermined event the system allocates an additional empty hash table.

5. The system according to claim 1, further comprising a sorter associative array and a comparison function, wherein a slot further comprises at least one of a score, a counter or a fingerprint.

6. The system according to claim 5, wherein the one or more processors are further configured to perform the following:
apply a respective hash function associated with a hash table to a key to compute a hash value;
perform at least one of:
determine a second score value as a first score value plus a slot score associated with the hash value; or
determine a second score value as the first score value;
replace the slot score associated with the hash value with the second score value;
apply the comparison function to the second score value and a threshold value of the sorter associative array; and
responsive to the comparison function returning true:
replace a respective key value in the sorter associative array with the second score value;
apply the comparison function to the second score value and a score of each key in the sorter associative array; and
responsive to the comparison function applied to a score of a key in the sorter associative array returning false, prune the key from the sorter associative array.

7. The system according to claim 5, wherein the one or more processors are further configured to perform the following:
apply a respective hash function associated with a hash table to compute a hash value of a key;
increment a count of a slot in a bucket associated with an address derived from the hash value;
apply the comparison function to the count of the slot and a threshold value of the sorter associative array; and
responsive to the comparison function returning true:
replace a respective key value in the sorter associative array with the count of the slot;
apply the comparison function to the count of the slot and a count of each key in the sorter associative array; and
responsive to the comparison function applied to a count of a slot in the sorter associative array returning false, prune the key from the sorter associative array.

8. The system according to claim 5, wherein the comparison function further comprises a comparison of a predetermined threshold length and the sorter associative array size.

9. The system according to claim 6, wherein the comparison function further comprises a comparison of a predetermined minimum significant score value and the second score value.

10. The system according to claim 7, wherein the comparison function further comprises a comparison of a predetermined minimum significant count value and the count of the slot.

11. The system according to claim 1, further comprising:
a sorter associative array and a comparison function, wherein a slot further comprises at least one of a score, a counter or a fingerprint;
a second system according to claim 1; and
a non-transitory computer readable medium storing executable instructions that, when executed by a processor, cause the system to perform the following:
responsive to a timer event, create a copy of the sorter associative array of the system; and
insert the copy of the sorter associative array into the second system.

12. The system according to claim 1, wherein a slot further comprises a Boolean field indicating its protection from eviction.

13. The system according to claim 1, wherein a bucket further comprises a plurality of candidate fingerprints, and the one or more processors are further configured to perform for insertion of a new key associated with a new value:
perform one or more condition checks, the condition checks comprising:
determining presence of at least one of an empty slot or a cold slots in the bucket associated with the address derived from the hash value; and
determining presence of the hash value in the plurality of candidate hash values; and
responsive to determining that none of the conditions checks is satisfied, abort performing insertion of the new key associated with the new value.

14. A processor-implemented method for data insertion, comprising:
applying a first hash function associated with a first hash table to the new key to compute a hash value;
responsive to existence of a first slot in a bucket associated with an address derived from the hash value, the first slot associated with an invalid integer index, placing the new key and the new value in the first slot, otherwise kicking a key and a value comprising a second slot in the bucket to a third slot; and
responsive to the first slot comprising a prior key and a prior value, removing the prior key and the prior value and releasing their resources.

15. The method according to claim 14, further comprising:
responsive to the first slot comprising a prior value, incrementing the maximum index and updating the slot value.

16. The method according to claim 14, further comprising:
incrementing the maximum index; and
responsive to a predetermined event, increasing the maximum index.

17. A system comprising:
a storage comprising:
one or more hash tables, each associated with one or more hash functions and comprising a plurality of buckets, each bucket comprising one or more slots, each slot comprising:
an integer index and a key
a maximum index; and
a capacity value;
one or more processors configured to perform the following in each of a plurality of iterations performed for insertion of a new key:
apply a first hash function associated with a first hash table to the new key to compute a hash value;
responsive to existence of a first slot in a bucket associated with an address derived from the hash value, the first slot associated with an invalid integer index, place the new key and the new value in the first slot, otherwise kick a key and a value comprising a second slot in the bucket to a third slot; and
responsive to the first slot comprising a prior key and a prior value, remove the prior key and the prior value and release their resources.

18. A system comprising:
a storage comprising:
one or more hash tables, each associated with one or more hash functions and comprising a plurality of buckets, each bucket comprising one or more slots, each slot comprising:
an integer index; and
one of a value and a key;
a maximum index; and
a capacity value;
one or more processors configured to perform the following in each of a plurality of iterations performed for insertion of one of a new key and a new value:
apply a first hash function associated with a first hash table to the new key to compute a hash value;
responsive to existence of a first slot in a bucket associated with an address derived from the hash value, the first slot associated with an invalid integer index, place one of the new key and the new value in the first slot, otherwise kick one of a key and a value comprising a second slot in the bucket to a third slot; and
responsive to the first slot comprising one of a prior key and a prior value, remove one of the prior key and the prior value and release their resources.

19. A non-transitory computer-readable storage medium storing computer-executable instructions that, when executed by a processor, cause the processor to execute a method for data insertion, the method comprising:
applying a first hash function associated with a first hash table to the new key to compute a hash value;
responsive to existence of a first slot in a bucket associated with an address derived from the hash value, the first slot associated with an invalid integer index, placing the new key and the new value in the first slot, otherwise kicking a key and a value comprising a second slot in the bucket to a third slot; and
responsive to the first slot comprising a prior key and a prior value, removing the prior key and the prior value and releasing their resources.

20. A computer program product comprising computer-executable instructions stored on a non-transitory computer-readable storage medium that, when executed by a processor of a system, cause the system to be configured to:
apply a first hash function associated with a first hash table to the new key to compute a hash value;
responsive to existence of a first slot in a bucket associated with an address derived from the hash value, the first slot associated with an invalid integer index, place the new key and the new value in the first slot, otherwise kick a key and a value comprising a second slot in the bucket to a third slot; and
responsive to the first slot comprising a prior key and a prior value, remove the prior key and the prior value and release their resources.
